(19) United States
(12) Patent Application Publication
(10) Pub. No.: US 2002/0003919 A1
(43) Pub. Date: Jan. 10, 2002

(54) Optical switch module

(76) Inventor: Masahito Morimoto, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/899,870

(22) Filed: Jul. 5, 2001

(30) Foreign Application Priority Data
Jul. 7, 2000 (JP) 206109/2000
Jun. 4, 2001 (JP) 168089/2001

(51) Int. Cl. G02B 6/35

(52) U.S. Cl. 385/18; 385/17

(57) ABSTRACT

The present invention provides an optical switch capable of freelyswitching N×M optical paths (N and M are positive integers) with less number of mirrors. A plurality of input-side optical fibers 1 are disposed along an end of a substrate and rotary mirrors 4 are aligned on the substrate 3 to individually reflect the light coming through the input-side optical fibers. Rotary mirrors 4 is placed in optical laths of the input-side optical fibers 1, respectively, and mutually shifted in position in the longitudinal directions of the input-side optical fibers 1. A plurality of output-side optical fibers 2 are individually disposed in areas where the light rays are reflected from the rotary mirrors 4, respectively. An incident light ray introduced through any input-side optical fiber can be outputted toward any output-side optical fiber responsively by rotation of a specified one of the rotary mirrors.

### BACKGROUND OF THE INVENTION

The present invention relates to an optical switch for switching optical paths or an optical switch module for use in an optical add/drop multiplexing system, which is used in optical communication system.

### RELATED ART

Compact optical switches using MEMS (Micro Electro Mechanical System) have been proposed, and one such example is a 4×4 matrix switch shown in FIG. 5. This optical switch is described in Abstract C-3-105, published in the general conference of The Institute of Electronics, Information and Communication Engineers in 2000.

As shown in FIG. 5(a), there is a matrix chip 35 having a face 25 on its one end, to which four input-side optical fibers 1 are arranged in parallel. A lens array 26 is disposed between the input-side optical fibers 1 and the end face 25. The lens array 26 includes lenses 27 each facing a connecting endface of each input-side optical fiber 1. Four parallel-arranged output-side optical fibers 2 are faced to the other end face 28 of the matrix chip 35. Another lens array 29 is disposed between the output-side optical fibers 2 and the end face 28. The lens array 29 includes lenses 30, each facing a connecting end face of each input-side optical fiber 2.

The matrix chip 35 is sectioned into 16-pieces (4×4=16) of matrices. As shown in FIFS. 5(b) and (c), each matrix is formed by arranging a moving electrode 23 on a fixed electrode substrate 21 via a frame substrate 22 and arranging a movable mirror 24 on the movable electrode 23.

In the optical switch shown in FIG. 5, electrostatically driving the movable electrode 23 supported by a spring enables the moving mirror 24 in a direction (an up-and-down direction in the drawing) perpendicular to the surface of the fixed electrode substrate 21, which switches optical paths.

For example, as shown in FIG. 5(b) and (c), some of the moving mirrors 24 shown by the solid lines in FIG. 5(a) are moved up higher than the upper surface of the frame substrate 22, while the remaining mirrors 24 shown by broken lines shown in FIG. 5(a) are drawn toward the fixed electrode substrate 21 so as to locate lower than the upper surface of the frame substrate 22. This allows the moving mirrors 24 shown by the solid lines in FIG. 5(a) to optically connect the input-side optical fibers 1 to the output-side optical fibers 2.

Because each moving mirror 24 is disposed movably in the perpendicular direction to the surface of the fixed electrode substrate 21, moving mirrors 24 located higher than the upper surface of the frame substrate 22 can be changed, whereby it is possible to change the combination of the input-side and output-side optical fibers 1 and 2 optically connected to each other.

The matrix switch shown in FIG. 5 is configured so that the switch is able to switch the optical paths into, for example, N×M ways (N, M: positive integer). However, the number of the moving mirrors 24 is required by “N×M” pieces, resulting in a complicated construction of the switch.

In addition, the optical switch shown in FIG. 5 has a problem that it does not have function of reflecting a plurality of incident light beams to a single output fiber for wavelength multiplexing systems, which is required for the optical switch. Additionally, there is another problem that it is impossible for the optical switch to have a configuration of switching N×M optical paths simultaneously.

### SUMMARY OF INVENTION

The present invention provides an optical switch module for solving the above problems.

A first embodiment of the present invention is an optical switch module, which comprises:

(a) N-pieces of input-side optical fibers are disposed in line along an end of X-axis direction of a plane substrate;

(b) rotary mirrors, the number of which is the same as that of the input-side optical fibers, are aligned in line in optical axes of the input-side optical fibers on the substrate so that each mirror is free from interrupting optical paths of the remaining mirrors;

(c) M-pieces of output-side optical fibers are disposed in line along a Y-axis directional end of the substrate; and

(d) a drive mechanism for rotating the mirrors so that an optical signal received through any of the input-side optical fibers is reflected toward any of the output-side optical fibers.

A second embodiment of the present invention is an optical switch module, wherein both of the X-axis and the Y-axis are perpendicular to each other.

A third embodiment of the present invention is an optical switch module, wherein a line of the mirrors is inclined to either the X-axis or the Y-axis by an angle of 30 to 60 degrees.

A fourth embodiment of the present invention is an optical switch module, wherein the number N of the input-side optical fibers is equal to or different from the number M of the output-side optical fibers.

A fifth embodiment of the present invention is an optical switch module, wherein the number N of the input-side optical fibers and the number M of the output-side optical fibers are integers selected from numbers of 2 to 10.

A sixth embodiment of the present invention is an optical switch module, wherein the input-side optical fibers or the output-side optical fibers are provided with a collimator lens at ends thereof.

A seventh embodiment of the present invention is an optical switch module, wherein the input-side optical fibers or the output-side optical fibers are provided with a multi-mode fiber with collimating functions at ends thereof.

An eighth embodiment of the present invention is an optical switch module, wherein the drive mechanism for rotating the mirrors is provided with a electrostatic motor.

A ninth embodiment of the present invention is an optical switch module, wherein the plane substrate is made up of a rectangular semiconductor substrate.

### BRIEF DESCRIPTION OF THE DRAWINGS

FIG. 1 shows an essential configuration of one embodiment of an optical switch according to the present invention.

FIG. 2 shows a variety of embodiments for the shape of a substrate and the arrangement of mirrors in the present invention.

FIG. 3 is an outlined view of an electrostatic motor for rotating a rotary mirror applied to the embodiment.

FIG. 4 explains a rotary mechanism installed in the electrostatic motor.

FIG. 5 exemplifies a conventional optical switch constructed using the MEMS technique.

### DETAILED DESCRIPTION

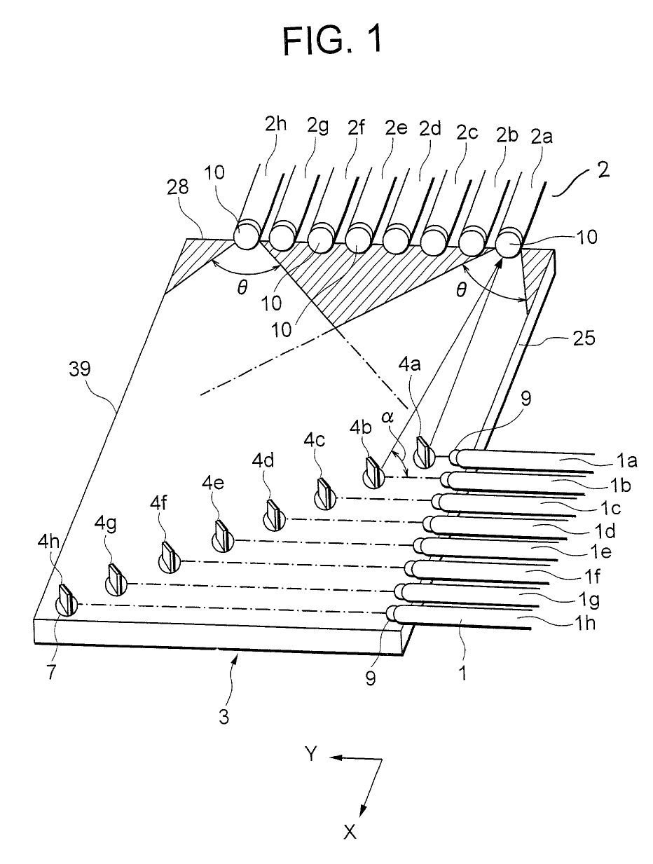

Embodiments of the present invention will now be described based on the accompanying drawings. Although the following is described about embodiments of the present invention, the present invention will not be limited to such embodiments. It should be understood that the present invention includes various embodiments realized by a person of ordinary skill in the art by arbitrarily combining embodiments that are described hereinafter. In the following description, the identical or similar components to those of the conventional optical switch employ the same references, the description being avoided from being repeated. FIG. 1 shows an essential configuration of one embodiment of an optical switch according to the present invention, in which X- and Y-directions perpendicular to each other are designated as shown therein.

As shown in FIG. 1, a plurality of input-side optical fibers 1 (1a to 1h; eight fibers in this case) are disposed in parallel along an end face 25 of a rectangular semiconductor substrate 3 at a pitch of, for example, 250 μm. Additionally, a plurality of output-side optical fibers 2 (2a to 2h; eight fibers in this case) is disposed above an end face 28 in the right direction to the end face 25 at a pitch of for example 250 μm As the semiconductor substrate 3, a silicon substrate having a thickness of, for example, 625 to 1000 μm is preferably used.

In the present embodiment, the input-side optical fibers 1a to 1h and the output-side optical fibers 2a to 2h are disposed at a pitch described above, a width required for disposing each set of the input-side optical fibers 1a to 1h and the output-side optical fibers 2a to 2h is about 1.75 mm. In addition, a distance from the input-side optical fiber 1a, which is located at an outermost position, to the end face 28 is 3 mm, while a distance from the output-side optical fiber 2h, which is located at an outermost position, to an end face 39 facing the end face 25 is 1 mm. In other words, the length of the X-directional end face of the semiconductor substrate 3 is about 5 mm and the length of the Y-directional end face 28 thereof is about 3 mm.

In the present embodiment, a plurality of rotary mirrors 4 (4a to 4h) are aligned in optical axes on the semiconductor substrate 3 in one-to-one correspondence to the input-side optical fibers 1a to 1h. The output-side optical fibers 2 are directed along light reflecting directions from the rotary mirrors 4, respectively. Each mirror 4 is shaped into a micro-mirror of which width is about 150 μm and of which height is about 300 μm, for instance.

Each of the rotary mirrors 4a to 4h, which corresponds to each of the input-side optical fibers 1a to 1h, is located in an optical axis extending from each of the input-side optical fibers 1a to 1h. At the same time, the rotary mirrors 4a to 4h are placed at different positions mutually shifted in the longitudinal directions (in the Y-direction) of the input-side optical fibers 1a to 1h. By way of example, the rotary mirrors 4a to 4h are arranged at a pitch of 350 μm in the Y-direction.

The maximum rotation angle of the rotary mirror 4a, which is located nearest to the end face 28, is 35 degrees and its rotation angle is changeable in eight steps of 0, 5, 10, 15, 20, 25, 30 and 35 degrees. Meanwhile, a rotation angle of 0 degree for each of the rotary mirrors 4a to 4h means that each rotary mirror is able to exactly reflect a light beam to the output-side optical fiber 2a located closest to the end face 25.

The maximum rotation angle of the rotary mirror 4b, which is located next to the rotary mirror 4a, is 33 degrees and its rotation angle is changeable in eight steps at every 4.7 degrees. Like this, each of the remaining mirrors 4b to 4h is changeable in rotation angle in eight steps at every appropriately set angle. The final mirror 4h can be rotated by 18 degrees at maximum and its rotation angle is changeable in eight steps at every 2.6 degrees.

In this way, each of the angles of the rotary mirrors 4a to 4h can be switched over in the eight steps, which makes it possible to arbitrarily combine the eight input-side optical fibers 1a to 1h and the eight output-side optical fibers 2a to 2h. This switchable configuration is generalized to design in a manner such that the mirrors are equal in number to the input-side optical fibers and equal in the number of steps of rotation angle to the output-side optical fibers. Such design makes it possible to connect each of the input-side optical fibers 1a to 1h to all of the output-side optical fibers 2a to 2h.

A collimator lens 9 is secured on each of connecting end faces of the input-side optical fibers 1, whilst a collimator 10 is secured on each of connecting end faces of the output-side optical fibers 2. The collimator lenses can be replaced by multi-mode fibers with collimating function.

In the present embodiment, the collimator lens 9 secured to the connecting end face of each input-side optical fiber 1 is constructed to convert input light, which has traveled through the input-side optical fiber 1, to parallel light rays at an efficiency of approximately 100 percent and sends out the parallel light rays toward a given rotary mirror 4.

The collimator lens 10 secured on the connecting end face of each output-side optical fiber 2 has a light-receiving angle which allows a given output-side optical fiber 2 to receive light reflected by the rotary mirrors 4 at an efficiency of substantially 100 percent (in the present embodiment, a maximum light-receiving angle è=70 degrees). In the present embodiment, securing both collimator lenses 9 and collimators 10 enables reflected light from the rotary mirrors 4 to be optically connected to all the output-side optical fibers 2, as long as the rotary mirrors 4 are located in an area other than the hatched areas on the substrate 3, as shown in FIG. 1. From a viewpoint of manufacturing, it is preferable that the mirrors be aligned straight at an angle of 30 to 60 degrees to both of the X- or Y-axes mutually crossing at the right angle, as shown in FIG. 1.

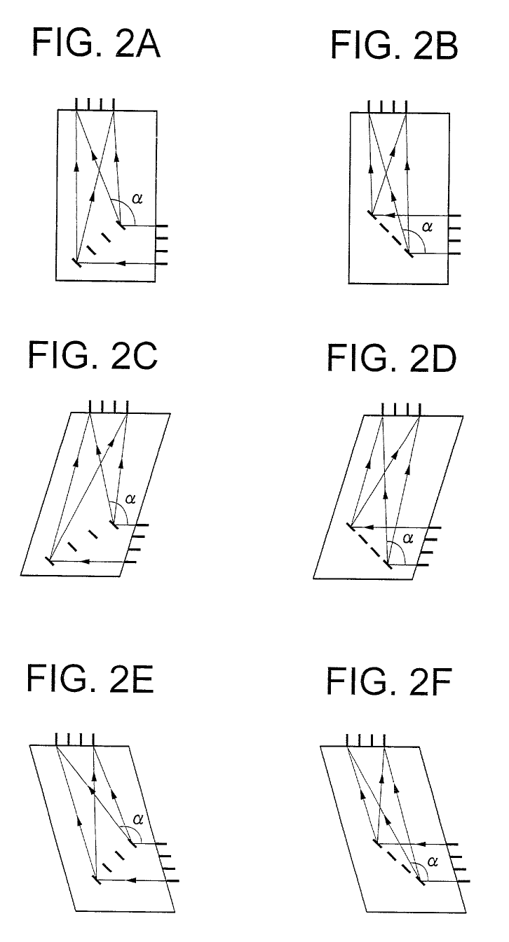

Although the above embodiment employs the rectangular substrate and the mirrors are arranged thereon, the present invention is not limited to the shape and arrangement. Alternative shapes and arrangement, to which the present invention can also be applied, are shown in FIGS. 2(a) to 2(f). The arrangement shown in FIG. 2(a) is the same as that in FIG. 1. The arrangement shown in FIG. 2(b) is realized by rotating the alignment of the mirrors in FIG. 2(a) by about 90 degrees. In each of FIGS. 2(c) to 2(f), the substrate is shaped into a parallelogram, where the mirrors can be arranged in a similar way to the alignment shown in each of FIGS. 2(a) and (b). In the shape of the substrate and arrangement of the mirrors, when taking less noise into account, it is preferable that a light reflection angle á at each mirror is as small as possible. From this point of view, the examples shown in FIG. 2(a), (b) and (d) is preferable to the remaining examples.

In the above configurations, each of the number N of the input-side optical fibers and the number M of the output-side optical fibers is four, but the numbers N and M are not limited so. Each of the numbers N and M for practically available optical switch modules is 2 to 10. When the numbers N and M are more than 10, the reflection angle is widened, thereby providing a broader reflection flux of light, which is undesirable. In contrast, when the numbers N and M are less than two, it is considered that that the optical switch module provided in the present invention is slightly complicated, compared to such numbers of optical fibers. Further, it is not always required that the numbers N and M be equal to each other, but those may be different integers from each other. Furthermore, though it is general that the X-axis and Y-axis crossing at the right angle, the present invention is not confined to such an angular configuration. As long as the condition that the light reflection angle á is for example an amount of 150 degrees or less is maintained, both X-axis and Y-axis are not required to be crossed at the right angle.

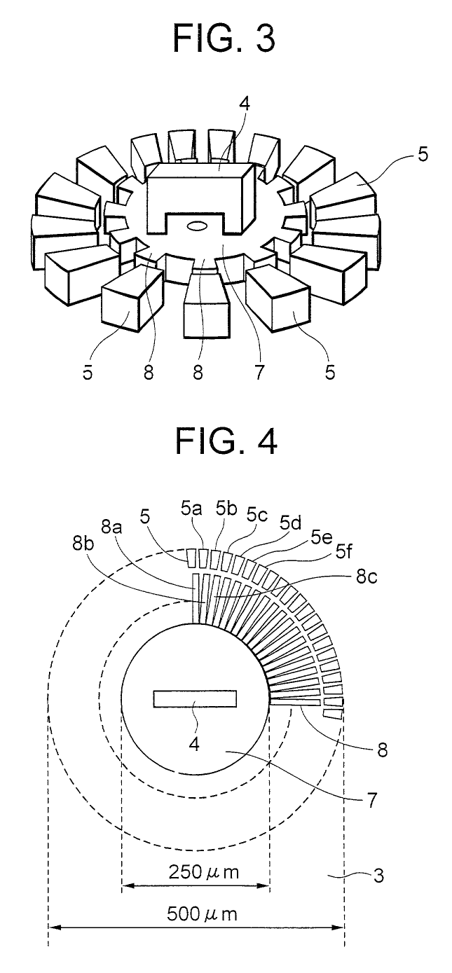

FIG. 3 shows a perspective view of an electrostatic motor (also, referred to as an electrostatic actuator) adopted as a rotary drive mechanism for each rotary mirror 4. This electrostatic motor will now be outlined. As shown in FIG. 3, the rotary mirror 4 is secured on a rotor 7. On the outer circumferential surface of the rotor 7 are provided with protrusions 8 each extending outward, which are located at intervals in the circumferential direction. Stators 5 that consist of divided pieces each opposing to the protrusions 8 of the rotor 7 are disposed at intervals.

In the electrostatic motor for driving each mirror 4, the diameter of the rotor 7 is for example 250 μm and the outer diameter of the divided stator 5 is for example 500 μm. The numbers of protrusions 8 and stators 5 are designated according to the rotation angle. The stators 5, which neighbor on each other, are disposed, by way of example, at intervals of a certain angle \grave{1} which corresponds to a rotation angle of each of the mirrors 4a to 4h at the center of the rotor 7. For example, the angle ì is 5 degrees for the rotary mirror 4a.

The rotor of the electrostatic motor is formed of P-type or N-type of semiconductor that accepts supply of positive and negative direct currents. On the other hand, pulsed current is supplied to the stators 5 to rotate them stepwise.

The operational principle of each rotary mirror 4 will now be described with reference to FIG. 4. For instance, in the configuration shown in FIG. 4, the protrusions 8a, 8b, 8c, . . . are charged positively. In contrast, the stators 5 adopt an alternating charge manner. Specifically, the divided pieces of the stators 5 are charged positively or negatively every other piece and their charge are changed at each time specified in a driving sequence. So at a certain time, the divided pieces 5a, 5c, 5e, . . . are charged positively, while the divided pieces 5b, 5d, 5f, . . . are charged negatively.

This charging causes Coulomb's forces. In addition, design is made such that, when making the protrusion 8a face to the divided piece 5a of the stator, the next protrusion 8b is located between the stator divided pieces 5b and 5c. Therefore, the operating forces are shifted from the center to yield a torque in the rotary direction, which causes the rotor 7 to rotate. Accordingly, controlling current generated in the direct electric circuit sequentially in time enables the mirror 4 to rotate by an arbitrary amount of angle. In other words, this makes it possible to obtain any rotation angle of the rotary mirror 4.

Alternatively, as an opposed way to the above, the protrusions 8a, 8b, 8c, . . . may be charged negatively. It is enough that in the divided pieces 5, the polarities thereof are set to be alternating every other piece. This kind of charge can be realized by connecting the whole protrusions 8 to a single direct electric charge and connecting the divided pieces 5 to a positive charge or a negative charge of direct alternating electric circuits, piece by piece.

Hence, for example, when the mirror 4a is rotated to an angle of 0 degrees, the light coming through the input-side optical fiber 1a is reflected by the rotary mirror 4a toward the output-side optical fiber 2a, and is transmitted. When the mirror 4a is rotated to an angle of 5 degrees, the light coming through the input-side optical fiber 1a is reflected by the rotary mirror 4a toward the output-side optical fiber 2b, and is transmitted.

As explained the light coming through the input-side optical fiber 1a is reflected by the rotary mirror 4a toward each of the out-put optical fiber 2a to 2h by changing the angle of the rotary mirror 4a by 5 degrees each time.

Similarly, the rotation angle step of each of the rotary mirrors 4b to 4h is defined for each of the mirrors 4b to 4h. Changing of the rotation angle step by step causes the light which is input through each of the input-side optical fibers 1b to 1h to be reflected by any of the rotary mirrors 4a to 4h toward any of the output-side optical fibers 2a to 2h, and is outputted through the optical fibers 2.

As described above, in the present embodiment, controlling the rotation angles of the rotary mirrors 4a to 4h makes it possible to output the light received through any of the input-side optical fibers 1a to 1h through any of the output-side optical fibers 2a to 2h. Accordingly, there can be provided a 8×8 optical switch or an optical add/drop multiplexing apparatus capable of freely changing combinations between the input-side optical fibers 1a to 1h and the output-side optical fibers 2a to 2h in a controlled manner.

In addition, in the case that the rotation angles of all rotary mirrors 4a to 4h are set to zero degree, the light rays input through all of the input-side optical fibers 1a to 1h can be multiplexed to be output through the single output-side optical fiber 2a. As understood from this example, the optical switch according to the present embodiment can be used as an optical switch module that has a function of freely combining optical waves.

Further, the present embodiment provides a compact and elaborate configuration in which the rotary mirrors 4a to 4h are formed on the semiconductor substrate 3 using the semiconductor processing technique. In addition, it is enough to provide the rotary mirrors 4a to 4h of which number is the same as that of the input-side optical fibers 1a to 1h, which can lower largely in the number of mirrors, compared to the conventional matrix switch.

In the present embodiment, the electrostatic force can be used to switch the rotation angles of each of the rotary mirrors 4a to 4h with ease. This provides easier switching of optical paths and optical multiplexing.

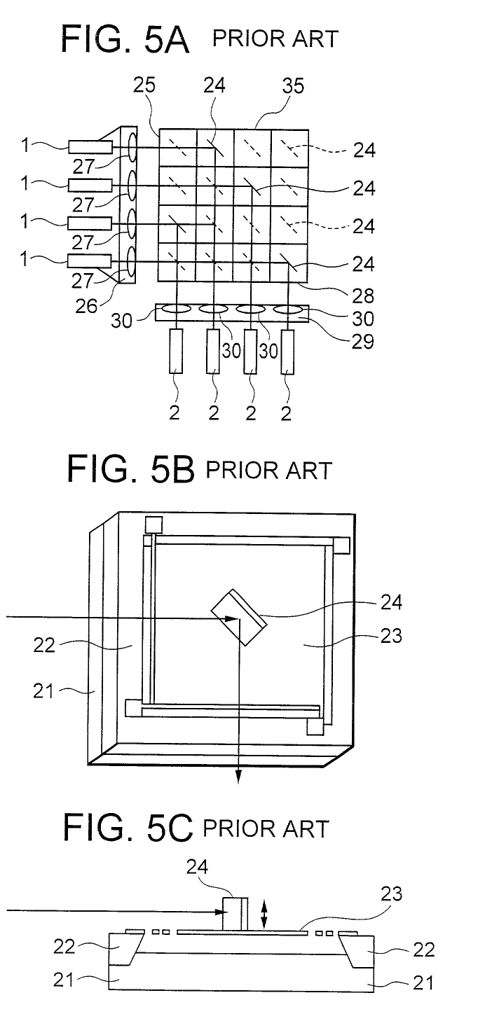

In comparison, the conventional optical switch shown in FIG. 5 does not have function of reflecting a plurality of incident light beams to a single output fiber for wavelength multiplexing systems, which is required for the optical switch. Additionally, the conventional optical switch does not provided a possibility of switching N×M optical paths simultaneously.

In contrast, the present embodiment uses the semiconductor substrate 3 as a substrate for the switch and the rotary mirrors 4 formed by using the semiconductor etching processing technique It is therefore possible to form the rotary mirrors with precision as can be obtained in processing of semiconductors, with the result that greatly compact optical switch modules can be constructed with precision It is preferred to plate the reflection surfaces of the mirrors 4 with gold or aluminum for raising efficiency of their reflections. How to produce the mirrors and electrostatic motors is disclosed in detail in, for example, “IEEE, pages 26-31, Vol, 5, No.1 (1999).” The outline of the disclosure is that masks to form mirrors and motors to be produced are prepared, and etching is repeated using photo resist so as to finally form electrostatic motors with mirrors on a substrate.

The present invention is not restricted to the foregoing embodiments, but can be practiced in a variety of other embodiments. For instance, the alignment pitch of the rotary mirrors 4a to 4h and the rotation angle of each of the rotary mirrors 4a to 4h, which are applied to the optical switch of the present invention, are not restricted to the values described in the foregoing embodiment. Appropriate variation may be set for those parameters. The alignment pitch of the rotary mirrors 4a to 4h can be determined, by way of example, by such parameters as maximum light-receiving angles of the collimator lenses 9 and 10 secured on the connecting end faces of the input-side and output-side fibers 1 and 2, waists of beams after being collected by the collimator lenses 9 and 10, the size of a chip, and/or a geometry that removes a light beam reflected by a certain rotary mirror 4 from being interrupted by another rotary mirror 4.

Though being rotated by the electrostatic motor in the foregoing present embodiment, each of the rotary mirrors 4 may be rotated using a stepping motor based on electromagnetic force. Alternatively each mirror is possible to have rotating means based on both electrostatic force and electromagnetic force.

In the foregoing embodiment, each of the input-side optical fibers 1 and the output-side optical fibers 2 is set to eight in number, but those numbers of optical fibers 1 and 2 are not limited to so. An appropriately set number is available. Although there is no intention to limit the number, the number of the optical fibers is preferably chosen from integers of 2 to 10.

For instance, the output-side optical fibers 2 can be formed such that they are larger in number than the input-side optical fibers 1, wherein there is excessive output-side optical fibers as reserve fibers which are usually out of use. In cases where the output-side optical fibers 2 or a counter party to which any of the output-side optical fibers 2 is connected is out of order, or the lines connected such as telephone lines are changed, malfunctioned optical paths are switched over to the reserve output-side optical fibers 2.

In the case of the optical switch wherein a large number of input light beams are multiplexed for use, there are some cases in which it is convenient to form the input-side optical fibers 1 larger in number than that of the output-side optical fibers 2. Thus, the numbers of input-side and output-side optical fibers 1 and 2 can appropriately be determined based on such factors as specifications.

The present embodiment employs the configuration that the input-side optical fibers 1 are disposed in line along the end face 25 of the semiconductor substrate 3 and the output-side optical fibers 2 are disposed in line along the end face 28 thereof. However, the disposal embodiments of those optical fibers 1 and 2 are not limited to the disclosed example. It is enough that both input-side optical fibers 1 and output-side optical fibers 2 are optically coupled with each other via the rotary mirrors 4 on the substrate. As long as this condition is met, the fibers 1 and 2 may appropriately be disposed in other ways.

Moreover, in the foregoing embodiment, each rotary mirror 4 (4a to 4h) related to each input-side optical fiber 1 (1a to 1h ) is disposed in the optical axis of the optical fiber 1 and the rotary mirrors 4 are mutually shifted in position in the longitudinal direction (Y-axis direction) of the input-side optical fibers 1. However, the disposal embodiment of the rotary mirrors 4 is not limited to such embodiment. In this case, the rotary mirrors 4 may also be set appropriately if only each rotary mirror 4 is disposed on the substrate correspondingly to each input-side optical fiber 1 on a one-by-one basis and reflects light toward a specified output-side optical fiber 2.

The present invention provides the following advantages. The present invention is constructed such that, correspondingly to each of a plurality of input-side optical fibers, a rotary mirror to reflect light coming through each input-side optical fiber is aligned on a substrate, while a plurality of output-side optical fibers are disposed to receive reflected light from the rotary mirrors. Accordingly changing rotation angles of the rotary mirrors enables the light coming through the input-side optical fibers to be outputted to any or all of the output-side optical fibers. It is therefore possible to freely switch optical paths.

In switching the optical paths, controlling the rotation angles of selected ones or all of the rotary mirrors makes it possible to reflect light coming through a plurality of arbitrary input-side optical fibers toward any one of the output-side optical fibers, thus the reflected light being transmitted. Accordingly, multiplexing of light that was not conducted by the conventional optical switch can be conducted.

Thanks to the present invention wherein a plurality of input-side optical fibers are disposed in parallel, a plurality of rotary mirrors are placed in their optical axes one by one, and the rotary mirrors are mutually shifted in position in the longitudinal directions of the input-side optical fibers, the optical switches according to the present invention can be designed with ease and efficiency for optical connection between the input-side and output-side optical fibers can be improved.

Because collimator lenses are individually secured on connecting end faces of at least one of the input-side optical fibers and the output-side optical fibers, the collimator lenses enables a steady optical connection between the input-side and output-side optical fibers.

Moreover, each of the collimator lenses secured on the connecting end faces of the input-side optical fibers is able to pass light coming through each input-side optical fiber toward each rotary mirror at an efficiency of substantially 100 percent. Each of the collimator lenses secured on the connecting end faces of the output-side optical fibers has a light-receiving angle that allows the light reflected by any mirror to be passed to each output-side optical fiber at an efficiency of substantially 100 percent. Therefore, optical connections between the input-side and output-side optical fibers via those collimator lenses can be realized in an improved condition.

There is also provided a further configuration wherein rotating means is provided which rotates the rotary mirrors with at least one of an electrostatic force and an electromagnetic force. Therefore, the rotary mirrors can be rotated with ease and with precision by the electrostatic or electromagnetic force, thereby contributing to a more improved optical connection.

In addition, the substrate and rotary mirrors, which are made of semiconductors such as silicon, are formed using the highly developed semiconductor processing technique. As a result, very compact-sized and accurately-operated optical switches can be manufactured.

There is also provided a construction in which the number of the input-side optical fibers is different from that of the output-side optical fibers. For example, if the output-side optical fibers are larger in number than that of the inputs-side optical fibers, the optical switch which makes it easier to cope with troubles or line changes can be provided. By contrast, the number of the input-side optical fibers is greater than that of the output-side optical fibers, an optical switch module convenient for multiplexing wavelengths can be constructed.

What we claim is:

1. An optical switch module, which comprises
(a) N-pieces of input-side optical fibers being disposed in line along an X-axis end of a plane substrate;
(b) rotary mirrors, the number of which is the same as that of the input-side optical fibers, being aligned in line in optical axes of the input-side optical fibers on the substrate so that each mirror is free from interrupting optical paths of the remaining mirrors;
(c) M-pieces of output-side optical fibers being disposed in line along a Y-axis directional end of the substrate; and
(d) a drive mechanism for rotating the mirrors so that an optical signal received through any of the input-side optical fibers is reflected toward any of the output-side optical fibers.

2. The optical switch module of claim 1, wherein both of the X-axis and the Y-axis are perpendicular to each other.

3. The optical switch module of claim 1, wherein a line of the mirrors is inclined to either one of the X-axis or the Y-axis by an angle of 30 to 60 degrees.

4. The optical switch module of claim 1, wherein the number N of the input-side optical fibers is equal to or different from the number M of the output-side optical fibers.

5. The optical switch module of claim 1, wherein the number N of the input-side optical fibers and the number M of the output-side optical fibers are integers selected from numbers of 2 to 10.

6. The optical switch module of claim 1, wherein the input-side optical fibers or the output-side optical fibers have collimator lenses at ends thereof.

7. The optical switch module of claim 1, wherein the input-side optical fibers or the output-side optical fibers are provided with a multimode fiber having collimating function at ends thereof.

8. The optical switch module of claim 1, wherein the drive mechanism for rotating the mirrors are provided with electrostatic motors.

9. The optical switch module of claim 1, wherein the plane substate is made up of a rectangular semiconductor-made substrate, the rectangle including a parallelogram.

10. The optical switch module of claim 2, wherein a line of the mirrors is inclined to either one of the X-axis or the Y-axis by an angle of 30 to 60 degrees.

11. The optical switch module of claim 2, wherein the number N of the input-side optical fibers is equal or different to or from the number M of the output-side optical fibers.

12. The optical switch module of claim 2, wherein the number N of the input-side optical fibers and the number M of the output-side optical fibers are integers selected from numbers of 2 to 10.

13. The optical switch module of claim 2, wherein the drive mechanism for rotating the mirrors are provided with electrostatic motors.

14. The optical switch module of claim 3, wherein a line of the mirrors is inclined to either one of the X-axis or the Y-axis by an angle of 30 to 60 degrees.

15. The optical switch module of claim 3, wherein the number N of the input-side optical fibers is equal to or different from the number M of the output-side optical fibers.

16. An optical switch module, which comprises
(a) N-pieces of input-side optical fibers being disposed in line along an X-axis end of a plane substrate;
(b) rotary mirrors, the number of which is the same as that of the input-side optical fibers, being aligned in line in optical axes of the input-side optical fibers on the substrate so that each mirror is free from interrupting optical paths of the remaining mirrors by inclination to the X-axis direction by a degree of 30 to 60 degrees;
(c) M-pieces of output-side optical fibers are disposed in line along a Y-axis end of the substrate, the Y-axis direction being perpendicular to the X-direction; and
(d) an electrostatic motor for rotating the mirrors so that an optical signal received through any of the input-side optical fibers is reflected to any of the output-side optical fibers.
